(19) United States
(12) Patent Application Publication
(10) Pub. No.: US 2025/0343246 A1
(43) Pub. Date: Nov. 6, 2025

(54) ELECTRODE PLATE FOR SECONDARY BATTERY, SECONDARY BATTERY INCLUDING SAME, AND METHOD OF MANUFACTURING SAME

(71) Applicant: Samsung SDI Co., Ltd., Yongin-si (KR)

(72) Inventors: Jaewook Lee, Yongin-si (KR); Sungsub Song, Yongin-si (KR); Leo Choi, Yongin-si (KR)

(73) Assignee: Samsung SDI Co., Ltd., Yongin-si (KR)

(21) Appl. No.: 18/920,702

(22) Filed: Oct. 18, 2024

(30) Foreign Application Priority Data
May 2, 2024 (KR) 10-2024-0058725

(51) Int. Cl. H01M 4/70; H01M 4/04; H01M 10/052; H01M 50/105; H01M 50/178

(52) U.S. Cl. CPC H01M 4/70; H01M 4/0433; H01M 10/052; H01M 50/105; H01M 50/178

(57) ABSTRACT

An electrode plate for a secondary battery, comprising: a standard sheet configured to include a standard substrate coated with an active material, the standard substrate comprising a base end and a standard end spaced apart from the base end by a standard width in a first direction; an extended sheet configured to comprise an extended substrate coated with the active material, the extended substrate comprising an extended end extended from the standard end by an extended width in the first direction; and a tab connected to the extended substrate to extend in the first direction, wherein at least one recess is provided to be spaced apart from the tab by a gap distance in a second direction perpendicular to the first direction and to expose the standard end.

### CROSS-REFERENCE TO RELATED APPLICATIONS

This present application claims priority to and the benefit under 35 U.S.C. § 119(a)-(d) of Korean Patent Application No. 10-2024-0058725, filed on May 2, 2024, in the Korean Intellectual Property Office, the entire disclosure of which is incorporated herein by reference.

### FIELD

The present disclosure relates to an electrode plate for a secondary battery, a secondary battery including the same, and a method of manufacturing an electrode plate for a secondary battery, and more particularly, to a positive electrode plate for a secondary battery, a stacked secondary battery including the same, and a method of manufacturing a positive electrode plate for a secondary battery.

### BACKGROUND

In general, secondary batteries are batteries that may be charged and discharged, as opposed to primary batteries which are unable to be recharged, and are used in a wide range from low-capacity batteries, in which a single cell is packaged in a pack and used to power a small and portable electronic device, to high-capacity batteries, in which a plurality of cells are connected and used to power large machinery such as electric vehicles and facility structures.

The above information disclosed in this Background section is for enhancement of understanding of the background of the present disclosure, and therefore, it may contain information that does not constitute related (or prior) art.

### SUMMARY

The present disclosure has been proposed to improve the problems described above, and an objective of the present disclosure is to provide an electrode plate for a secondary battery having an enlarged size by removing a residual active material layer in a tab region.

Another aspect of the present disclosure is to provide a secondary battery having the electrode plate having an enlarged size as described above.

Another aspect of the present disclosure is to provide a method of manufacturing the electrode plate for a secondary battery as described above.

These and other aspects and features of the present disclosure will be described in or will be apparent from the following description of embodiments of the present disclosure.

According to one or more embodiments of the present disclosure, an electrode plate for a secondary battery, the electrode plate including: a standard sheet configured to include a standard substrate coated with an active material, the standard substrate comprising a base end and a standard end spaced apart from the base end by a standard width in a first direction; an extended sheet configured to include an extended substrate coated with the active material, the extended substrate comprising an extended end extending from the standard end by an extended width in the first direction; and a tab connected to the extended substrate to extend in the first direction, wherein at least one recess may be provided such that the at least one recess is spaced apart from the tab by a gap distance in a second direction perpendicular to the first direction and the standard end is exposed.

In some embodiments, the electrode plate may further include a residual uncoated portion extending from the extended substrate having a predetermined residual thickness in the first direction and integrally connected to the tab and the extended substrate, the residual uncoated portion comprising an uncoated end spaced apart from the extended end by the residual thickness, wherein the tab protrudes from the uncoated end in the first direction.

In some embodiment, the recess may include a through-hole penetrating the residual uncoated portion and an extended groove capable of communicating with the through-hole and exposing the standard end, wherein a portion of the extended sheet being removed by an amount corresponding to the extended width from the extended end.

In some embodiments, a depth of the recess may be a sum of a depth of the through-hole and a depth of the extended groove, and the depth of the through-hole and the depth of the extended groove are set complementarily to maintain the depth of the recess constant, and the extended width and the residual thickness are configured complementarily to maintain the depth of the recess constant.

In some embodiments, in a case where the standard width may be 60 mm and the depth of the recess may be set to 0.9 mm, the extended width may be set to a range of 0.3 mm to 0.7 mm.

In some embodiments, the tab may be integrally connected to the extended substrate and protrudes from the extended end in the first direction.

In some embodiments, the recess may include an extended recess exposing the standard end, with a portion of the extended sheet being removed by an amount corresponding to the extended width from the extended end.

In some embodiments, a depth of the extended groove may be fixed to be equal to a depth of the recess.

In some embodiments, the recess may be provided as a stepped portion spaced apart from the tab to expose a standard end having a line shape in the second direction.

In some embodiments, the gap distance is greater than or equal to 0.5 mm and less than or equal to 1.5 mm.

According to one or more embodiments of the present disclosure, a secondary battery includes: an electrode assembly configured to include a plurality of negative electrode plates each of the plurality of negative electrode plates comprising a negative electrode tab, a plurality of positive electrode plates having a size smaller than the size of the negative electrode plates, alternately stacked with the negative electrode plates in a third direction to have a same stacking distance from edges of the negative electrode plates, and each of the plurality of negative electrode plates comprising a positive electrode tab, and a plurality of separators disposed between the negative electrode plates and the positive electrode plates; electrode leads configured to include a single negative electrode lead joined to the negative electrode tab and a single positive electrode jointed to the positive electrode tab; and a battery can configured to include the electrode assembly and the electrode leads and the battery can including electrode terminals connected to the electrode leads, wherein the positive electrode plate may include a standard sheet configured to include a standard substrate coated with an active material, the standard substrate comprising a base end and a standard end spaced apart from the base end by a standard width in a first direction perpendicular to the third direction; an extended sheet configured to include an extended substrate coated with the active material, the extended substrate comprising an extended end extending from the standard end by an extended width in the first direction; and a tab connected to the extended substrate to extend in the first direction, wherein at least one recess may be provided to be spaced apart from the tab by a gap distance in a second direction perpendicular to the first direction and to expose the standard end.

In some embodiments, the positive electrode plate may further include a residual uncoated portion extending from the extended substrate having a predetermined residual thickness in the first direction and integrally connected to the tab and the extended substrate, the residual uncoated portion comprising an uncoated end spaced apart from the extended end by the residual thickness, wherein the tab protrudes from the uncoated end in the first direction.

In some embodiments, the recess may include a through-hole penetrating the residual uncoated portion and an extended groove communicating with the through-hole and exposing the standard end, with a portion of the extended sheet being removed from the extended end by an amount corresponding to the extended width.

In some embodiments, a depth of the recess may be a sum of a depth of the through-hole and a depth of the extended groove, and the depth of the through-hole and the depth of the extended groove are set complementarily to maintain the depth of the recess constant, and the extended width and the residual thickness are configured complementarily to maintain the depth of the recess constant.

In some embodiments, the stacking distance may be set to a distance between edges of the negative electrode plates and the extended end and varies depending on the residual thickness.

In some embodiments, the tab may be integrally connected to the extended substrate and protrudes from the extended end in the first direction, and the recess may include an extended recess exposing the standard end, with a portion of the extended sheet being removed from the extended end by an amount corresponding to the extended width.

In some embodiments, the embodiments may be realized by providing a method of manufacturing an electrode plate for a secondary battery, the method including supplying an electrode plate sheet comprising an active material layer of an active material applied over a substrate having a width in a first direction and a length in a second direction and an uncoated portion provided on a peripheral portion of the substrate to which the active layer may be not applied; controlling a stamping machine comprising a tab punch, a base punch positioned symmetrically with the tab punch in the first direction, and an auxiliary punch protruding from a bottom of the tab punch toward the base punch to set a distance between the auxiliary punch and the base punch in the first direction as a standard width; aligning the bottom of the tab punch to overlap the uncoated portion; and partially removing the electrode plate sheet using the stamping machine to form a recess exposing a base end which may be a portion of the substrate cut by the base punch, a tab which may be an uncoated portion corresponding to the tab punch, and a standard end corresponding to the auxiliary punch, the standard end being a portion of the substrate cut to be spaced apart from the base end by the standard width in the first direction; and exposing the active material layer covering the standard end through the recess.

In some embodiments, the tab punch may include a pair of punch bodies spaced apart from each other in the second direction and may be disposed to have a predetermined gap distance in the second direction from opposite sides of the punch bodies, and the recess may be configured to be spaced apart from the tab by the gap distance.

In some embodiments, the bottom of the tab punch may be aligned with the uncoated portion to be spaced apart from the active material layer to form a residual uncoated portion between the tab and the active material layer, and the recess may include a through-hole penetrating the residual uncoated portion and an extended groove communicating with the through-hole and exposing the standard end, with a portion of the extended sheet being removed from an extended end by an amount corresponding to the extended width.

In some embodiments, the bottom of the tab punch may be aligned with an extended end, which may be an end of the active material layer, such that the tab may be directly connected to the extended end, and the recess may be formed as an extended groove recessed from the extended end to the standard end.

In the above-described electrode plate for a secondary battery, a secondary battery having the electrode plate, and a method of manufacturing the electrode plate for a secondary battery according to exemplary embodiments of the disclosure, the area of the active material layer may be easily increased by providing a conventional standard sheet having a standard size and an extended sheet extending from the conventional standard sheet to have an extended width set from the standard size. Accordingly, the capacity of the electrode plate and the capacity of the stacked secondary battery having the electrode plate may be easily increased.

In particular, depending on the alignment position of the bottom of the tab punch and the uncoated portion, the surface area of the active material layer may be variably adjusted by increasing the extended width of the extended sheet by the maximum protruding length of the auxiliary punch. Accordingly, the capacity of the electrode plate may be variably increased.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a plan diagram showing an electrode plate for a secondary battery according to some embodiments of the present disclosure;

FIG. 2 illustrates across-sectional diagram of the electrode plate for a secondary battery according to some embodiments of the present disclosure shown in FIG. 1, taken along line a-a′;

FIG. 3 illustrates the configuration of a conventional electrode plate formed on a substrate including a base end as shown in FIG. 1, according to some embodiments;

FIG. 4 illustrates a modified embodiment of the electrode plate according to a secondary battery shown in FIG. 1, according to some embodiments;

FIG. 5 illustrates another modified embodiment of the electrode plate for a secondary battery shown in FIG. 1, according to some embodiments;

FIG. 6 illustrates another modified embodiment of the electrode plate for a secondary battery shown in FIG. 1, according to some embodiments;

FIG. 7 illustrates a perspective diagram showing a secondary battery including the electrode plate for a secondary battery shown in FIG. 1, according to some embodiments;

FIG. 8 illustrates a perspective diagram showing the electrode assembly shown in FIG. 7, according to some embodiments;

FIG. 9 schematically illustrates the arrangement relationship between the positive electrode plate and the negative electrode plate of the electrode assembly shown in FIG. 8, according to some embodiments;

FIGS. 10 to 14 illustrates process diagrams showing a method of manufacturing an electrode plate for a secondary battery according to some embodiments of the present disclosure; and

FIGS. 15 to 17 illustrates process diagrams showing a method of manufacturing an electrode plate for a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A secondary battery includes an electrode assembly and a battery can. In the electrode assembly, a positive electrode plate, a negative electrode plate, and a separator are sequentially stacked. The battery can contains an electrolyte or a solid electrolyte and the electrode assembly.

Depending on the configuration of the secondary battery, such electrode assemblies may be formed of a wound assembly having a jelly roll structure in which long sheet-like positive and negative electrode plates are wound with separators provided therebetween and a stacked assembly in which a plurality of positive and negative electrode plates are sequentially stacked with separators provided therebetween.

The stacked assembly may include a plurality of positive electrode plates each having a positive electrode tab and a plurality of negative electrode plates having a negative electrode tab, wherein the positive electrode plates and the negative electrode plates are alternately stacked with separators provided therebetween. Accordingly, stacked assemblies are mainly used as electrode assemblies for medium to large secondary batteries storing high capacity energy.

Generally, the negative electrode plate of a stacked assembly is configured to be larger in size than a positive electrode plate thereof. In a case in which the size of the negative electrode plate is smaller than the positive electrode plate, positive ions generated by the positive electrode plate may leave the negative electrode plate and migrate to the separator disposed on a peripheral portion of the negative electrode plate, thereby causing damage to the separator and short circuit failure of the battery.

Accordingly, the capacity of a stacked secondary battery, which is a secondary battery including a stacked assembly, is affected more by the size of the positive electrode plate than by the size of the negative electrode plate, and various efforts have been made to increase the size of the positive electrode plate without exceeding the size of the negative electrode plate in order to improve the capacity of the stacked secondary battery.

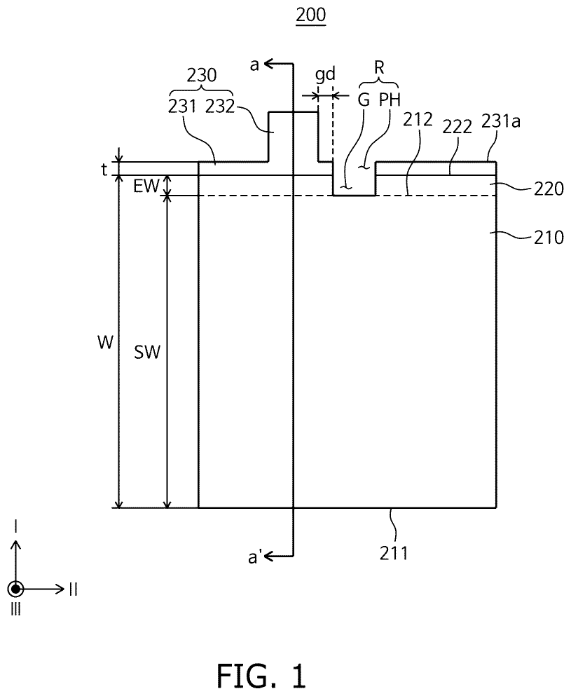

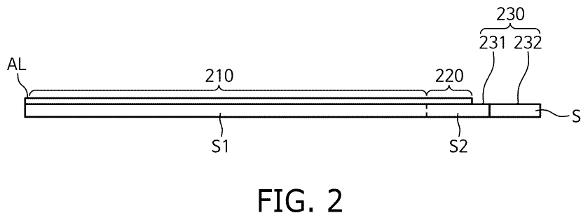

FIG. 1 illustrates a plan diagram showing an electrode plate for a secondary battery according to some embodiments of the present disclosure, and FIG. 2 illustrates across-sectional diagram of the electrode plate for a secondary battery according to some embodiments of the present disclosure shown in FIG. 1, taken along line a-a′.

Referring to FIGS. 1 and 2, an electrode plate 200 for a secondary battery according to some embodiments of the present disclosure includes a standard sheet 210, an extended sheet 220, and a tab 232, wherein a standard end 212, i.e., an edge region in a first direction I of the standard sheet 210, may be exposed through a recess R.

For example, the electrode plate 200 for a secondary battery may include a substrate S, which is a conductive substrate having a width and a length set in a first direction I and a second direction II, and an active material layer AL applied to cover a portion of the upper surface of the substrate S.

Herein, the base material S may include a base end 211 positioned on the lower portion in the first direction I, a standard end 212 spaced apart from the base end 211 by a standard width SW in the first direction I, and an extended end 222 spaced apart from the standard end 212 by an extended width EW in the first direction I.

Accordingly, the substrate S may include a standard substrate S1 defined by the base end 211 and the standard end 212 and an extended substrate S2 defined by the standard end 212 and the extended end 222.

The standard substrate S1 is a substrate on which the active material layer AL having the same size as a conventional electrode plate is disposed. The standard substrate S1 and the active material layer AL applied over the standard substrate S1 may be provided as the standard sheet 210 having the standard width SW in the first direction I. In the present embodiment, the active material layer AL is disposed to cover the front surface of the standard substrate S1, so that the standard sheet 210 may include the active material layer AL and the standard substrate S1 having the same sizes.

Accordingly, the standard end 212 is set as an end corresponding to the width of the conventional electrode plate in the first direction I.

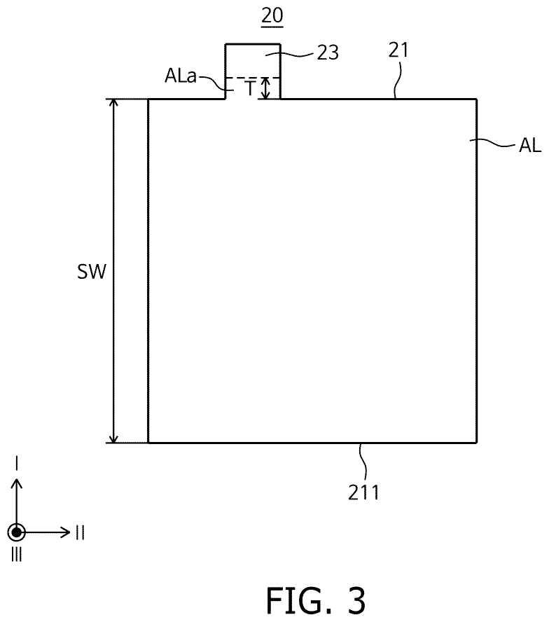

FIG. 3 illustrates the configuration of a conventional electrode plate formed on a substrate including a base end as shown in FIG. 1, according to some embodiments. Referring to FIG. 3, a conventional electrode plate 20 including a tab 23 may be formed by stamping an electrode plate sheet including a substrate (not shown) having a base end 211 on the lower portion in a first direction I and an active material layer AL applied to a portion of the upper surface of the substrate.

In this case, the conventional stamping process is performed so that up to a portion of the top end of the active material layer AL is stamped in order to prevent an uncoated portion from being included in the tab 23. As a result, a residual active material layer ALa is positioned under the tab 23.

Accordingly, the tab 23 formed by the stamping process has the active material residual layer ALa having a tab residual thickness T at the bottom of the tab, and a portion of the active material layer AL adjacent to the tab 23 is also removed by the stamping process by a thickness corresponding to that of the active material residual layer Ala, thereby reducing the size of the active material layer AL of the conventional electrode plate 20.

In a case where a secondary battery is formed using the conventional electrode plate 20 shown in FIG. 3 as a positive electrode plate, the position of the positive electrode plate relative to the negative electrode plate is set based on the top of the active material residual layer ALa, so that the active material 20 layer AL is removed by a thickness corresponding to the tab residual thickness T, thereby reducing the capacity of the positive electrode plate.

Referring to FIGS. 1 and 2, in the present embodiment, the tab 232 may be formed by stamping the uncoated portion, i.e., a peripheral portion of the substrate S to which the active material layer AL is not applied, thereby limiting removal of the active material layer AL during the stamping process. That is, the size of the active material layer AL may be increased by extending the active material layer AL from the standard substrate S1. The extended substrate S2 is a substrate extended by the extended width EW in the first direction I from the standard substrate S1, and is provided as an extended sheet 220 in which the same active material layer AL as the standard sheet 210 is disposed on the upper surface thereof. Accordingly, the extended end 222 forms the end of the active material layer AL in the electrode plate 200.

In other words, the extended sheet 220 may be extended in the first direction I by the extended width EW from the standard sheet 210 and an active material may be applied to the upper surface to increase the size of the active material layer AL. Accordingly, the capacity of the secondary battery including the electrode plate 200 for a secondary battery may be improved. For example, the extended sheet 220 has substantially the same configuration as the standard 15 sheet 210.

The tab 232 extends in the first direction I to be connected the extended substrate S2 and is not provided with any active material. Accordingly, the tab 232 may be formed from the conductive substrate S.

The standard substrate S1, the extended substrate S2, and the tab 232 may form a single substrate, and an active material may be applied to the upper surfaces of the standard substrate S1 and the extended substrate S2 to provide the active material layer AL.

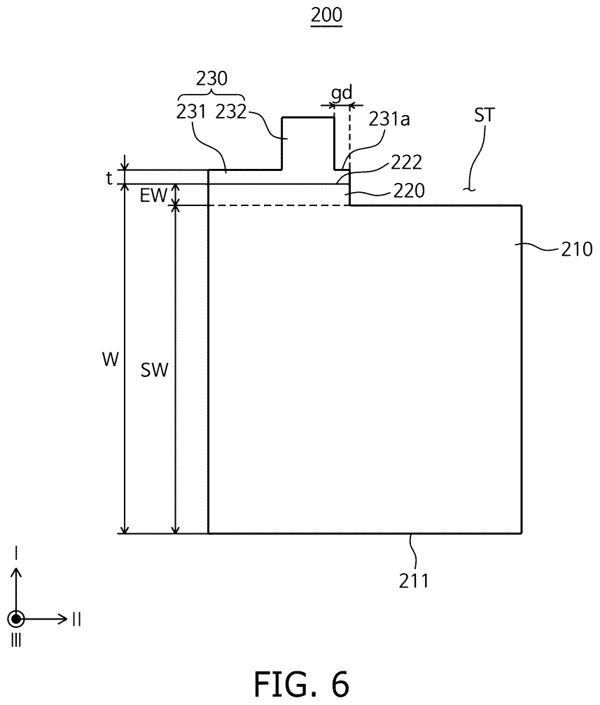

Accordingly, portions of the electrode plate 200 for a secondary battery, from the base end 211 to the extended end 222, may function as an electrode, and an electrode lead (400 in FIG. 6) may be connected to the tab 232 connected to the extended end 222. Hereinafter, the width of the active material layer AL from the base end 211 to the extended end 222, which is the end of the active material layer AL, is referred to as the electrode width W.

In the present embodiment, the electrode plate 200 for a secondary battery may be provided as a positive electrode plate for a stacked secondary battery, which is smaller in size than the negative electrode plate.

The base substrate(S) may include a current collector as a conductive plate 310 and a positive electrode active material layer on the current collector. The positive electrode active material layer may include a positive electrode active material and may further include a binder and/or a conductive material (e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change(e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

AI may be used as the current collector, but is not limited thereto.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}I_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}GbO₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFₑPO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the tab 232 may be directly or indirectly connected to the extended substrate S2. That is, depending on the position of a tab punch, the tab may be directly and integrally connected to the extended substrate S2 or may be connected to the extended substrate S2 via a residual uncoated portion 231 described later.

The residual uncoated portion 231 may include a plain end 231a extending from the extended substrate S2 such that a predetermined residual thickness t extends in the first direction I and spaced apart from the extended end 222 by the residual thickness t, and may be integrally connected to the tab 232 and the extended substrate S2.

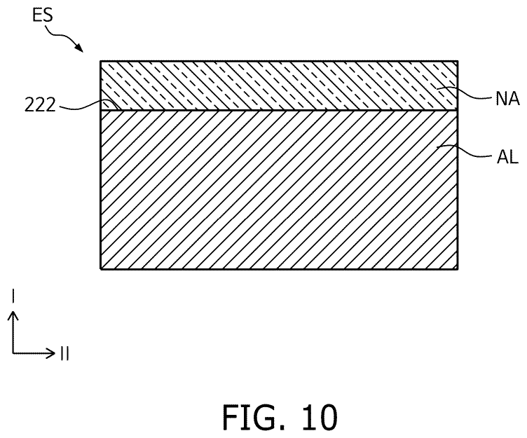

In the electrode plate 200 of the present embodiment, after the uncoated portion (NA in FIG. 10), which is an uncoated region of the substrate S, is stamped out so as not to interfere with the active material layer AL, the unremoved residual region of the uncoated portion NA is provided with as the residual uncoated portion 231. Accordingly, a distance to the active material layer AL, which is set according to the stamping position for the uncoated portion NA, is provided as the residual thickness t, which is the thickness of the residual uncoated portion 231.

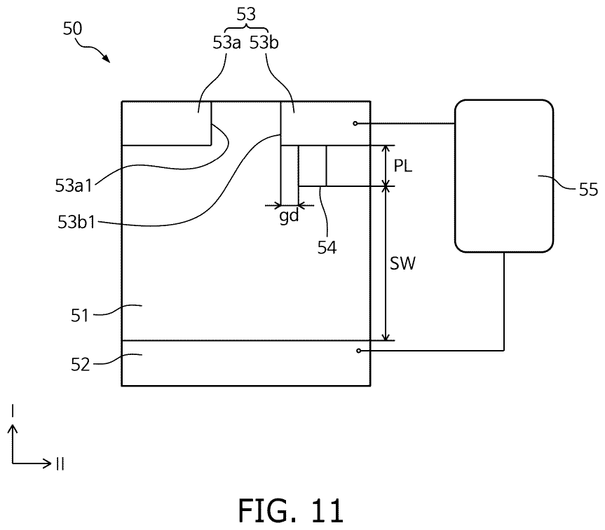

The residual uncoated portion 231 may be integrally connected to the extended end 222. In this case, the tab 323 is disposed to extend from the residual uncoated portion 231 to correspond to the shape of a tab punch (53 in FIG. 11). The tab 232 may extend from the residual uncoated portion 231 to have a set length, and may be joined to an electrode lead.

The electrode plate 200 with the tab 232 formed thereon is transported along a transportation line to the electrode assembly process. In a conventional transportation line, the electrode plate 200 is recognized by detecting the active material layer AL disposed on the standard end 212.

Accordingly, the electrode plate 200 may have a recess R through which the residual uncoated portion 231 and the extended end 222 are partially removed to expose the standard end 212. In the present embodiment, the standard end 212 may be exposed through the recess R and the active material layer AL over the standard end 212 may be detected, so that information about the electrode plate 200 being transported may be obtained.

For example, the recess R may include a through-hole PH penetrating the residual uncoated portion 231 and an extended groove G communicating with the through-hole PH and is recessed from the extended end 222 to a depth corresponding to the extended width EW to expose the standard end 212.

In a case where the stamping is performed using a stamping machine (50 in FIG. 11) additionally provided with an auxiliary punch (54 in FIG. 11), the recess R is formed by the auxiliary punch 54 and the uncoated portion NA is cut by the tab punch 53 to which the auxiliary punch 54 is coupled, thereby forming the tab 232.

Accordingly, the residual thickness of the residual uncoated portion 231 and the sizes of the through-hole H and the extended groove G may vary depending on the position of the tab punch 53 of the stamping machine 50.

In this case, the auxiliary punch 54 having a protrusion shape with a protruding length (PL in FIG. 11) corresponding to a maximum value of the extended width EW is disposed below the tab punch 53, and the recess R having a shape corresponding to the auxiliary punch 53 is provided to expose the standard end 212. Accordingly, a portion of the residual uncoated portion 231 is cut and provided as the through-hole PH, and the extended sheet 220 below the residual uncoated portion 231 is cut to communicate with the through-hole PH and provided as the extended groove G. Therefore, the depth of the recess R is the sum of the depth of the through-hole H and the depth of the extended groove G.

In this case, the depth of the recess is set to the protruding length PL of the auxiliary punch 54 and thus is a fixed value as a device characteristic. The residual thickness t depends on the position of the tab punch 53, and thus the depth of the through-hole H and the depth of the extended groove G may vary depending on the position of the tab punch 53.

Accordingly, the depth of the through-hole H and the depth of the extended groove G are configured to have a complementary relationship to each other so that the depth of the recess R is maintained constant. Similarly, the extended width EW and the residual thickness t may also have a complementary relationship to each other while maintaining the depth of the recess R constant.

In particular, the recess R may be spaced apart from the tab 232 by a set gap distance gd. In a case where the active material layer AL disposed on the standard end 212 is detected by a light sensor in a subsequent transportation line, the detected light incident at an inclination may be reflected by the tab 232 so as not to reach the active material layer AL.

Accordingly, the tab 232 and the recess R may be configured to have the set gap distance gd so that the standard end 212 may be reliably detected even in a case where the detected light is inclined light. In a case where the electrode plate 200 moves along the transportation line, the standard end 212 may be detected with high accuracy even in a case where the detected light is inclined detected light, and thus information about the electrode plate 200 may be reliably obtained.

Accordingly, the gap distance gd may be set to generally reduce detection defects of the electrode plate 200 in the transportation line. For example, the gap distance gd may be set in the range of about 0.5 mm to about 1.5 mm. However, the gap distance gd may vary depending on the characteristics of light emitted by the light sensor.

The electrode plate detection process may be performed by a conventional detection process during transportation of the electrode plate by detecting the standard end 212 exposed through the recess R, and the size of the active material layer AL may be increased by the surface area of the extended sheet 220 divided by the extended groove G.

For example, in a case where the stamping process is performed by setting the standard width SW to 60 mm and adding the auxiliary punch 54 having a protruding length of 0.9 mm, the extended width EW may range from about 0.3 mm to about 0.7 mm depending on the residual thickness t, which is the distance by which the tab punch 53 is spaced apart from the extended end 222 in the uncoated portion NA.

Accordingly, the electrode plate 200 is configured to have an electrode width W in the range of about 60.3 mm to 60.7 mm, so that the surface area of the active material layer AL may be increased and the capacity increase effect may be achieved compared to the conventional electrode plate 20 having an electrode width W of 60 mm.

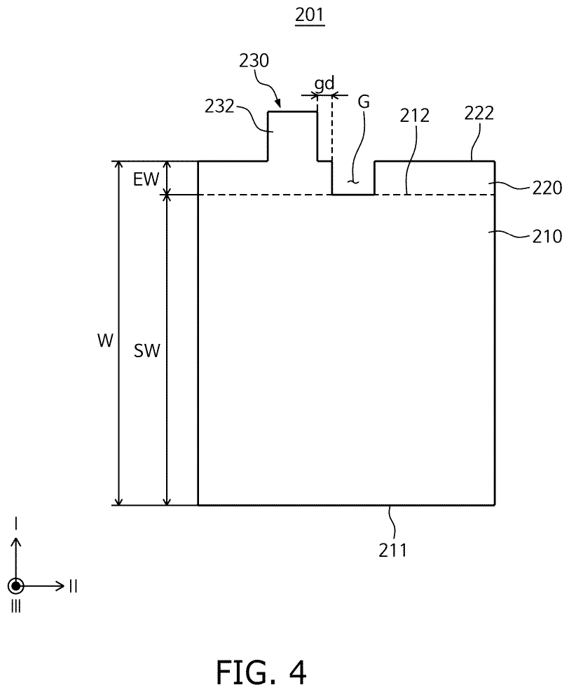

FIG. 4 illustrates a modified embodiment of the electrode plate according to a secondary battery shown in FIG. 1.

A first modified electrode plate 201 shown in FIG. 4 has substantially the same configuration as the electrode plate 200 shown in FIG. 1, except that the maximum width MW and the electrode width W are set to be the same. Accordingly, the same reference numerals will be used in FIG. 4 for the same components as in FIG. 1, and further detailed description is omitted.

Referring to FIG. 4, the first modified electrode plate 201 may be obtained by the stamping process performed in a state where the tab punch 53 is aligned with the extended end 222 which is the end of the active material layer AL.

Accordingly, the recess R exposing the standard end 212 may include only the extended groove G, and the depth of the extended groove G may be set to a maximum value. In this case, the tab 232 may be directly connected to the extended sheet 220 without a separate intervening structure such as the residual uncoated portion 231 of FIG. 1.

Because the first modified electrode plate 201 is not provided with the residual uncoated portion 231, the depth of the extended groove G is configured to be the same as the protruding length PL of the auxiliary punch 54, which is the depth of the recess R. Because the protruding length PL is the maximum value of the extended width EW that may be obtained in the case of forming the recess R using the provided auxiliary punch 54, the first modified electrode plate 201 may have the maximum extended width that may be obtained. Accordingly, the capacity of the first modified electrode plate 201 may be increased by expanding the surface area of the extended sheet 220 to a maximum size.

In this case, the main punch and the active material layer AL may be controlled so as not to interfere with each other by accurately aligning the tab punch 53 and the extended end 222. Accordingly, the surface area of the active material layer AL may be prevented from decreasing during the stamping process for forming the tab 232. At this time, the recess R of the first modified electrode plate 201 may also be positioned to have the set gap distance gd from the tab 232, as in the case of the recess R provided in the electrode plate 200. The gap 20) distance gd between tab 232 and the recess R has substantially the same configuration and function as the gap distance gd of the electrode plate 200 described with reference to FIG. 1. For example, in a case where the standard width SW is set to 60 mm and the stamping process is performed by adding the auxiliary punch 54 having a protruding length PL of 0.9 mm, the extended width EW may be set to 0.9 mm, which is the same as the protruding length PL. Accordingly, the electrode width W may also be set to about 60.9 mm to generally increase the capacity increase effect compared to the conventional standard sheet 210 having an electrode width W of 60 mm.

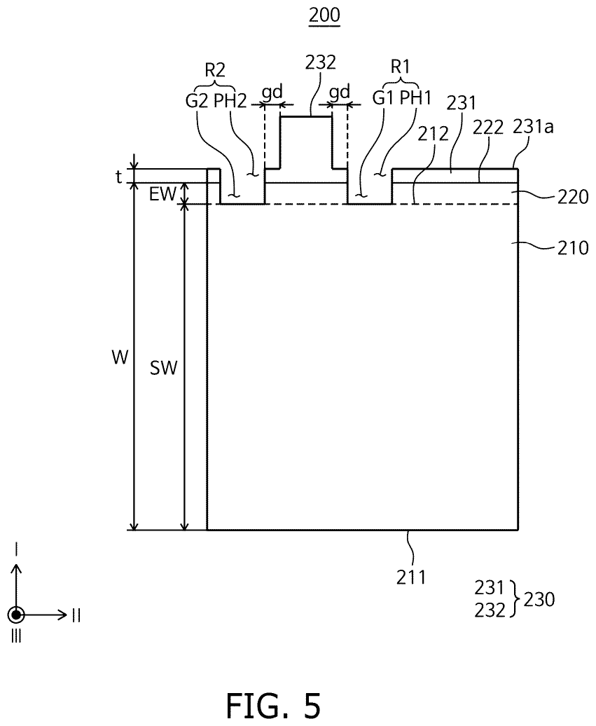

FIG. 5 illustrates another modified embodiment of the electrode plate for a secondary battery shown in FIG. 1, and FIG. 6 illustrates another modified embodiment of the electrode plate for a secondary battery shown in FIG. 1.

A second modified electrode plate 202 and a third modified electrode plate 203 shown in FIGS. 5 and 6 have substantially the same configuration as the electrode plate 200 shown in FIG. 1, except for the number and shape of recesses R. Accordingly, the same reference numerals will be used in FIGS. 5 and 6 for the same components as in FIG. 1, and further detailed description is omitted.

Referring to FIG. 5, the second modified electrode plate 202 may have a first recess R1 and a second recess R2 disposed symmetrically about the tab 232. A pair of auxiliary punches may be disposed on the main punch to simultaneously form the first recess R1 and the second recess R2 disposed symmetrically about the tab 232. Accordingly, the standard end 212 is exposed substantially at the same time through the first recess R1 and the second recess R2, which may increase detection accuracy for the active material layer AL disposed on the standard end 212 in the subsequent transportation line. One or more recesses R may be disposed depending on the configuration characteristics of the electrode plate detection device disposed in the transportation line.

Referring to FIG. 6, the third modified electrode plate 203 may include a stepped portion ST in which the extended sheet 220 is partially removed to expose the standard end 212 on one side of the tab 232. Accordingly, the third deformation electrode plate 203 may expose the standard end 212 in a line shape to increase detection accuracy for the third deformation electrode plate 203 during the transportation process.

The size and shape of the stepped portion ST may be variously set depending on detection precision desired for the transportation process and the characteristics of the detection device. In particular, the stepped portion ST may be spaced apart from the tab by the set gap distance gd.

In the electrode plate 200 for a secondary battery according to embodiments of the present disclosure, the extended sheet 220, which is connected to the standard sheet 210 to expose the standard end 212 by the recess R and to have the extended width EW from the standard end 212, may be provided. The extended width EW may be easily adjusted by adjusting the protruding length PL of the auxiliary punch 53 attached to the stamping machine 50 and the distance between the tab punch 53 and the extended end 222. Accordingly, the capacity of the electrode plate 200 for a secondary battery may be increased.

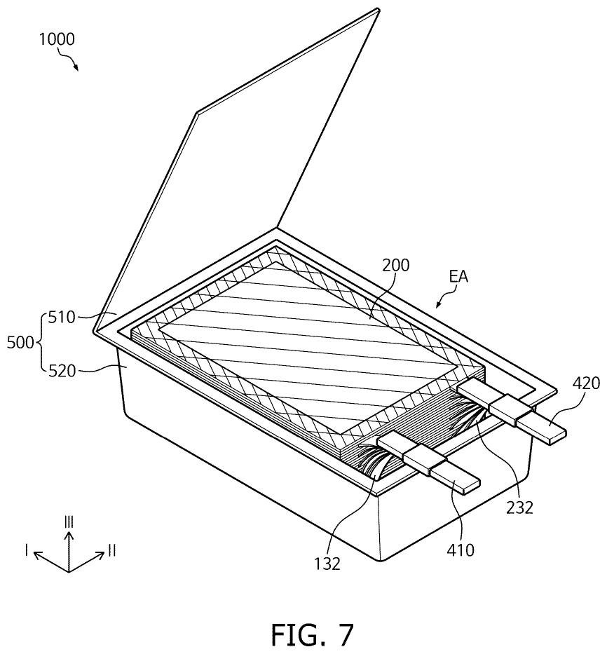

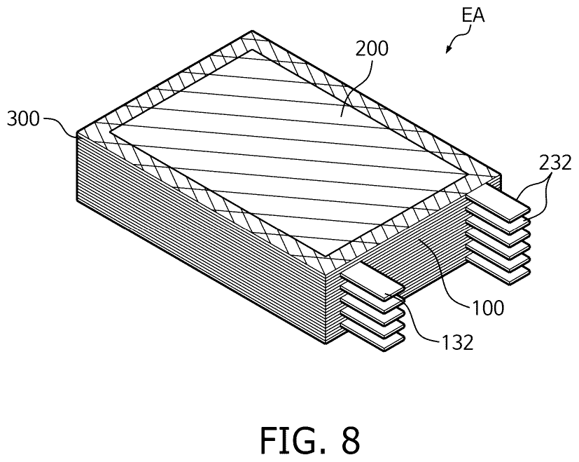

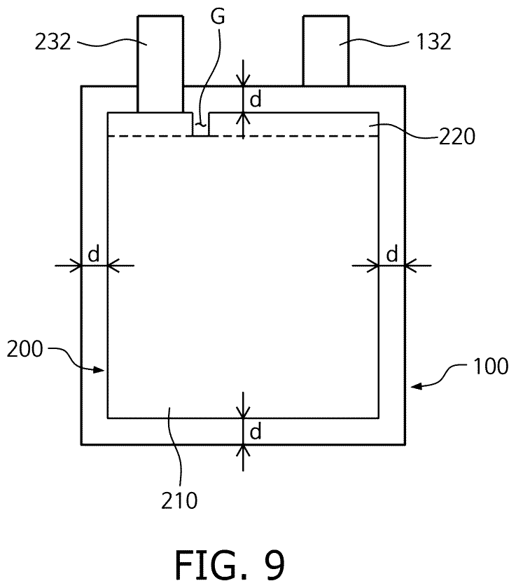

FIG. 7 illustrates a perspective diagram showing a secondary battery including the electrode plate for a secondary battery shown in FIG. 1, and FIG. 8 illustrates a perspective diagram showing the electrode assembly shown in FIG. 7. FIG. 9 schematically illustrates the arrangement relationship between the positive electrode plate and the negative electrode plate of the electrode assembly shown in FIG. 8.

Referring to FIGS. 7 to 9, a secondary battery 1000 according to some embodiments of the present disclosure may include an electrode assembly EA, electrode leads 400, and a receptacle 500, the electrode assembly EA including positive electrode plates 200a having an extended sheet 220.

The stacked electrode assembly EA may include a plurality of negative electrode plates 100 and a plurality of positive electrode plates 200a stacked on one another. The stacked electrode assembly EA may be received inside the receptacle 500, be sealed from the outside, and perform charging and discharging operations by means of an electrolyte filling the inside thereof. Electrode terminals provided on the receptacle 500 may be electrically connected to the electrode assembly EA inside the receptacle 500 through the electrode leads 400.

For example, the electrode assembly EA may include: the negative electrode plates 100 each including a negative electrode tab 132; the positive electrode plates 200a having a smaller size than the negative electrode plates 100, alternately stacked with the negative electrode plates 100 in a third direction III to have the same stacking distance d from the edges of the negative electrode plates 100, and each including a positive electrode tab 232; and a plurality of separators 300 disposed between the negative electrode plates 100 and the positive electrode plates 200a.

For example, the electrode assembly EA may include: a plurality of negative electrode plates 100 each including a negative electrode tab 132; a plurality of positive electrode plates 200a having a smaller size than the negative electrode plates 100, alternately stacked with the negative electrode plates 100 in a third direction Ill to have the same stacking distance d from the edges of the negative electrode plates 100, and each including a positive electrode tab 232; and a plurality of separators 300 disposed between the negative electrode plates 100 and the positive electrode plates 200a.

Each of the negative electrode plates 100 is provided as a structure in which an electrode slurry, i.e., a mixture of a negative electrode active material, a conductive material, and a binder, is pressed onto a negative electrode substrate, i.e., the flexible flat conductive plate 310, using rolling rollers.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

A negative electrode tab 132 connected to an uncoated portion of the negative electrode material may be provided as a connector for protruding outward to be connected to a negative electrode lead 410.

For example, the positive electrode plates 200a may have a smaller size than the negative electrode plates 100, and may be alternately stacked with the negative electrode plates 100 in the third direction III such that the positive electrode plates 200a have the same stacking distance d from the edges of the negative electrode plates 100.

In order to limit damage to the separator from by radiated cations, the positive electrode plates 200a are configured to be smaller in size than the negative electrode plates 100. In the present embodiment, the positive electrode plates 200a are stacked at the same stacking distance d from the edges of the respective negative electrode plates 100. Accordingly, the positive electrode plates 200a are disposed at positions spaced apart from the entire edges of the negative electrode plates 100 by the same stacking distance.

In the present embodiment, the negative electrode plates 100 may be disposed such that the negative electrode plates 100 have a width of 61.2 mm and the positive electrode plates 200a have a stacking distance of at least 0.3 mm from the edges of the respective negative electrode plates 100. Accordingly, the positive electrode plate 200a may have a width of up to 60.9 mm.

The positive electrode plates 200a of the present embodiment have substantially the same configuration as the electrode plate for a secondary battery 200 and the first to third modified electrode plates 201, 202, and 203 described with reference to FIGS. 1, 2, and 4 to 6. Accordingly, the same reference numerals are used in the positive electrode plates 200a for the same components as in the electrode plates 200 and the first to third modified electrode plates 201, 202, and 203.

Accordingly, the area of the positive electrode active material layer AL may be increased and the capacity of the positive electrode plates 200a may be increased by providing the extended sheet 220 adjacent to the positive electrode tab 232.

In particular, the extended width EW, i.e., the width of the extended sheet 220, is set to a range of about 0.3 mm to about 0.9 mm, so that the size of the standard sheet 210 having a width of 60 mm may be increased. Accordingly, the positive electrode plates 200a may be expanded and the capacity thereof may be increased.

The separators 300 may be disposed between the negative electrode plates 100 and the positive electrode plates 200a, respectively, to electrically separate the negative electrode plates 100 and the positive electrode plates 200a from each other. For example, the separators 300 may be made of a microporous material to allow cations to migrate, and the microporous material may include an olefin or an equivalent thereof.

In particular, the separators 300 are provided to have a size greater than 0.5 mm from peripheral edges of the negative electrode plates 100 so that the negative electrode plates 100 and the positive electrode plates 200a may be sufficiently separated by the separators 300.

Accordingly, the negative electrode plates 100 and the positive electrode plates 200a may be stacked such that the negative electrode tabs 132 and the positive electrode tabs 232 are aligned with each other, such that the electrode assembly EA may be provided as a stacked electrode assembly.

The electrode leads 400 may include a single negative electrode lead 410 welded to the negative electrode tabs 132 and a single positive electrode lead 420 welded to the positive electrode tabs 232.

The electrode leads 400 may connect the electrode assembly EA inside the receptacle 500 to electrode terminals (not shown) provided on the outer surface of the receptacle 500. Accordingly, the electrode assembly EA may be electrically connected to the outside via the electrode leads 400 and the electrode terminals.

The receptacle 500 may be provided as a hexahedral structure having sufficient strength and rigidity to separate the interior space from the exterior. For example, the receptacle 500 may have a can structure, such as an aluminum can or a SUS can, or a pouch case.

After the electrode assembly EA is received in the interior space of the can structure, the can structure may be sealed using the cap assembly having electrode terminals, thereby completing a secondary battery. In another example, a secondary battery may be completed by receiving the electrode assembly EA in the receiving space of the receptacle 520 and joining the electrode assembly EA to a lid assembly 510 that isolates and seals the receiving space RS from the outside.

FIGS. 10 to 14 illustrates process diagrams showing a method of manufacturing an electrode plate for a secondary battery according to an embodiment of the present disclosure. FIGS. 10 to 14 disclose a method of manufacturing the electrode plate 200 for a secondary battery shown in FIG. 1. Accordingly, in FIGS. 10 to 14, the same reference numerals are used for the same components as in FIGS. 1 and 2, and further detailed description is omitted.

Referring to FIG. 10, first, an electrode plate sheet ES having an active material layer AL and an uncoated portion NA is provided by partially coating a substrate S with an active material.

For example, the substrate S is implemented an oblong collector having a width in a first direction I and a length in a second direction II, the active material is applied to one surface of the substrate S to form the active material layer AL, and a peripheral portion without the applied active material is provided as an uncoated portion NA.

At this time, the end of the active material layer AL located at the boundary with the uncoated portion NA may be provided as the extended end 222 to form the boundary of the electrode. The extended end 222 of the electrode plate sheet ES may be provided as the extended end 222 of the electrode plate 200 in the stamping described later.

The electrode plate sheet ES may be unwound from a feed source, such as a feed reel (not shown), and fed into a die at a notching part (not shown). A stamping machine 50 for stamping the uncoated portion NA of the electrode plate sheet ES to form a tab 232 may be disposed in the notching part.

Referring to FIG. 11, the stamping machine 50 may be adjusted to set the distance between the auxiliary punch 54 and the base punch 52 in the first direction I to a standard width SW.

For example, the stamping machine 50 may include a stamping body 51, a tab punch 53 disposed on the stamping body 51 to form the tab 232 on the uncoated portion NA, a base punch 52 positioned symmetrically with the tab punch 53 in the first direction I, and an auxiliary punch 54 protruding from the bottom of the tab punch 53 toward the base punch 52.

The electrode plate sheet ES is disposed on a stamping die (not shown), and the stamping machine 50 is disposed above the stamping die to partially cut the electrode plate sheet ES as the tab punch 53, the auxiliary punch 54, and the base punch 52 move downward.

For example, the base punch 52 may include a stamping punch disposed above a lower peripheral portion positioned symmetrically with the uncoated portion NA of the electrode plate sheet ES, and the tab punch 53 may include a stamping punch disposed above the uncoated portion NA.

The base punch 52 may include a line-shaped single stamping punch extending in the second direction II, and the tab punch 53 may include a pair of punch bodies 53a and 53b spaced apart from each other in the second direction II.

Accordingly, the uncoated portion NA corresponding to the space between the pair of punch bodies 53a and 53b may be formed as the tab 232 without being removed by the stamping of the tab punch 53.

In particular, the auxiliary punch 54 is disposed to be spaced apart from at least one of opposite sides 53a1 and 53b1 of the pair of punch bodies 53a and 53b by a gap distance gd set in the second direction II.

The auxiliary punch 54 may include a protruding member having a set protruding length PL and width from the back surface of at least one of the punch bodies 53a and 53b toward the base punch 52. As will be described later, a recess R formed to correspond to the auxiliary punch 54 may be formed to have a recess depth c corresponding to the protruding length PL of the auxiliary punch 54 and a recess width corresponding to the width of the auxiliary punch 54.

At this time, the stamping machine 50 may adjust the position of the punches to a standard position by the stamping controller 55. For example, the stamping controller 55 may set the distance between the base punch 52 and the auxiliary punch 54 positioned below the tab punch 53 to the standard width SW.

In the present embodiment, the distance between the base punch 52 and the auxiliary punch 54 may be set to the standard width SW by fixing one of the base punch 52 and the tab punch 53 and moving the other of the base punch 52 and the tab punch 53.

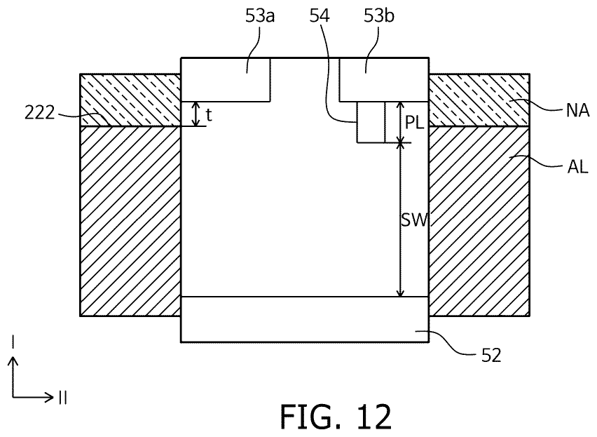

Referring to FIG. 12, as the standard position adjustment of the punches is completed, the stamping controller 55 may drive the base punch 52, the tab punch 53, and the auxiliary punch 54 to perform stamping on the electrode plate sheet ES.

At this time, the stamping controller 55 may set the stamping position on the uncoated portion NA such that the bottom of the tab punch 53 is spaced apart from the active material layer AL. The stamping controller 55 may set the stamping position to overlap the uncoated portion NA such that the bottom of the tab punch 53 does not interfere with the active material layer AL. Accordingly, removal of a portion of the active material layer AL during the stamping may be prevented.

In particular, the stamping controller 55 may set the position of the tab punch 53 such that at least a portion of the auxiliary punch 54 interferes with the active material layer AL. Accordingly, it may be ensured that the active material layer AL is exposed through the recess R formed by the auxiliary punch 54.

The stamping controller 55 may set the stamping position such that the active material layer AL interferes with at least a portion of the auxiliary punch 54 and the bottom of the tab punch 53 is aligned with the uncoated portion NA.

With the stamping position being set, the stamping controller 55 may simultaneously lower the base punch 52, the tab punch 53, and the auxiliary punch 54 to perform the stamping on the electrode plate sheet ES.

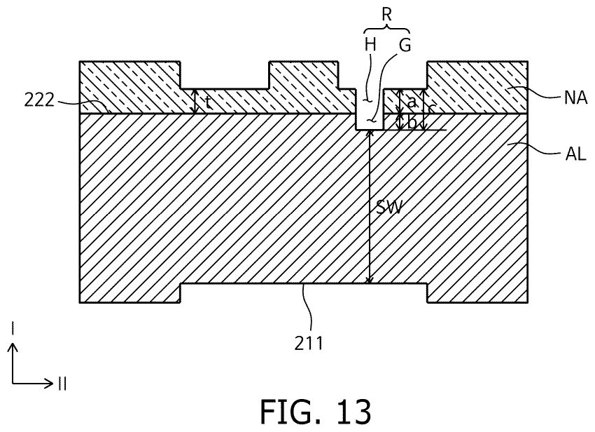

Referring to FIG. 13, the electrode plate sheet ES may be partially removed by the stamping machine 50 to form the tab 232 and the recess R.

The portion of the base material S cut by the base punch 52 may form the base end 211. The tab 232, which is the uncoated portion NA having a shape formed corresponding to the tab punch 53, and the recess R exposing the standard end 212 may be formed, wherein the standard end 212 is a portion of the base material S cut by the auxiliary punch 54 so as to be spaced apart from the base end 211 by the standard width SW in the first direction I. Accordingly, the active material layer AL covering the standard end 212 may be exposed through the recess R.

The base punch 52 may stamp a lower peripheral portion of the electrode plate sheet ES to partially remove the active material layer AL and the substrate S from the lower peripheral portion. The end of the electrode plate sheet ES cut by the base punch 52 may be provided as the base end 211 of the electrode plate 200.

The tab punch 53 may cut the uncoated portion NA to be spaced apart from the active material layer AL, so that the uncut uncoated portion NA in the space between the punch bodies 53a and 53b may be formed as the tab 232. Accordingly, the residual uncoated portion 231 is positioned between the tab 232 and the extended end 222 of the active material layer AL, and the tab 232 may be connected to the extended substrate S2, which is the substrate underlying the active material layer AL, via the residual uncoated portion 231.

At this time, the auxiliary punch 54 protruding from the back surface of at least one of the punch bodies 53a and 53b removes the residual uncoated portion 231 and the active material layer AL under the residual uncoated portion 231 substantially at the same time to form the recess R.

In particular, because the auxiliary punch 54 is disposed to have the gap distance gd from the opposite sides of the punch bodies 53a and 53b, the recess R may also be formed to have the set gap distance gd from the tab 232.

Furthermore, because the base punch 52 and the auxiliary punch 54 are set to be spaced apart by the standard width SW, the region of the active material layer AL corresponding to the bottom surface of the recess R may be provided as the standard end 212.

Accordingly, the recess R may include a through-hole H penetrating the residual uncoated portion 231 and an extended groove G communicating with the through-hole H and recessed from the extended end 222, which is the end of the active material layer AL, to the standard end 212.

Accordingly, the recess depth c, i.e., the depth of the recess R, corresponds to the protruding length PL of the auxiliary punch 54 and thus is fixed due to the shape of the auxiliary punch 54. However, the depths of the through-hole H and the extended groove G may be vary depending on the position of the bottom of the tab punch 53.

The recess depth c, which is the depth of the recess R, is the sum of a first depth a, which is the depth of the through-hole H, and a second depth b, which is the depth of the extended groove G, and the first depth a and the second depth b may be set complementary to each other so that the recess depth c remains constant.

In other words, in a case where the recess depth c corresponding to the protruding length PL is kept constant, the depth of the extended groove G decreases as the thickness of the residual uncoated portion 231 increases according to the position of the bottom of the tab punch 53, and the depth of the extended groove G increases as the thickness of the residual uncoated portion 231 decreases.

Accordingly, the residual thickness of the residual uncoated portion 231 and the extended width EW of the extended sheet 220 may be set complementary to each other while maintaining the recess depth c corresponding to the protruding length PL constant.

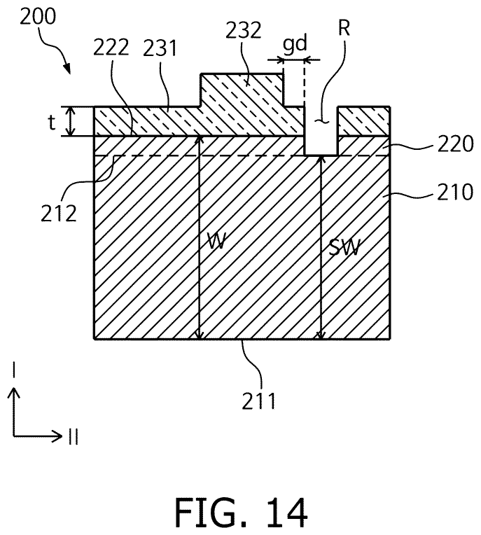

Referring to FIG. 14, the stamped electrode plate sheet ES may be cut into unit electrode plates to complete electrode plates 200 for a secondary battery.

Each of the electrode plates 200 for a secondary battery may include the recess R exposing the standard end 212 and the residual uncoated portion 231 between the tab 232 and the extended substrate S2. The surface area of the active material layer AL may be extended by the extended sheet 220 and the standard end 212 may be sufficiently exposed for the electrode plates 200 to be sufficiently recognized by a conventional detection means during transportation of the electrode plates 200.

Accordingly, each of the electrode plates 200 having an increased surface area of the active material layer AL may be recognized without any additional configuration change in a conventional transportation line while increasing the capacity of the electrode plate 200 for a secondary battery.

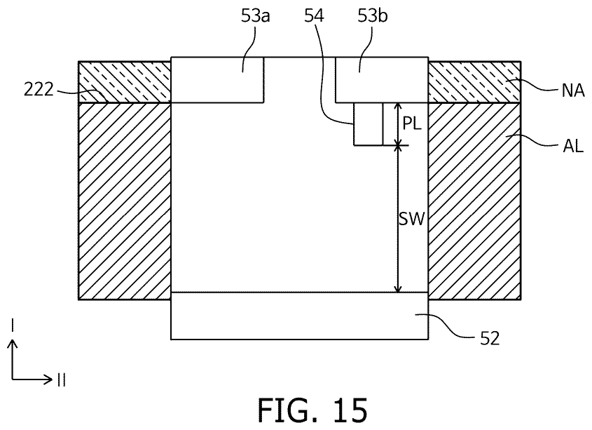

FIGS. 15 to 17 illustrates process diagrams showing a method of manufacturing an electrode plate for a secondary battery according to another embodiment of the present disclosure. FIGS. 15 to 17 disclose a method of manufacturing the first modified electrode plate 201 shown in FIG. 1. Accordingly, in FIGS. 15 to 17, the same reference numerals are used for the same components as in FIGS. 2 and 4, and further detailed description is omitted.

Referring to FIG. 15, after standard positioning adjustment of the punches is completed as described in FIG. 10, the stamping controller 55 may drive the base punch 52, the tab punch 53, and the auxiliary punch 54 to perform stamping on the electrode plate sheet ES.

At this time, the stamping controller 55 may set the bottom of the tab punch 53 to be aligned with the extended end 222 of the active material layer AL. The stamping controller 55 may align the tab punch 53 so that the bottom of the tab punch 53 is positioned closest to the active material layer AL while satisfying the condition that the bottom of the tab punch 53 does not interfere with the active material layer AL. Accordingly, all regions of the auxiliary punch 54 are arranged to interfere with the active material layer AL.

As the stamping position is set, the stamping controller 55 may lower the base punch 52, the tab punch 53, and the auxiliary punch 54 substantially at the same time to perform stamping on the electrode plate sheet ES.

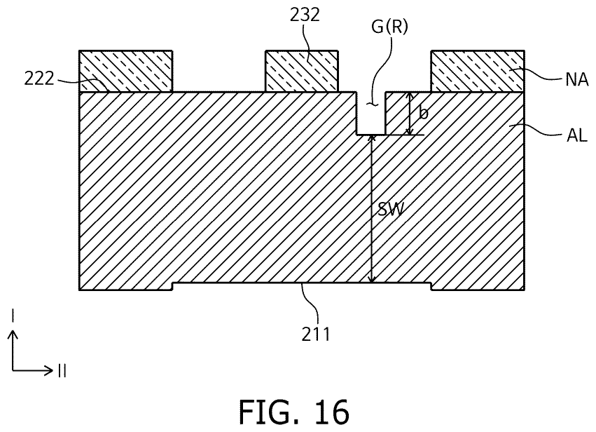

Referring to FIG. 16, the electrode plate sheet ES may be partially removed by the stamping machine 50 to form a tab 232 and a recess R.

A portion of the base material S cut by the base punch 52 may form the tab 232. The tab 232, which is the uncoated portion NA having a shape formed corresponding to the tab punch 53, and the recess R exposing the standard end 15 212 may be formed, wherein the standard end 212 is a portion of the base material S cut by the auxiliary punch 54 so as to be spaced apart from the base end 211 by the standard width SW in the first direction I. Accordingly, the active material layer AL covering the standard end 212 may be exposed through the recess R.

The base end 211, the tab 232, and the recess R may be formed by the method described with reference to FIG. 13.

In this case, the tab 232 may be connected directly from the extended end 222, and the recess R may be formed only from the extended groove G. Accordingly, the recess depth c may be configured to be substantially the same as the second depth b, and the extended groove G may have a maximum depth. That is, the depth of the extended groove G may be configured to be the same as the protruding length PL of the auxiliary punch 54.

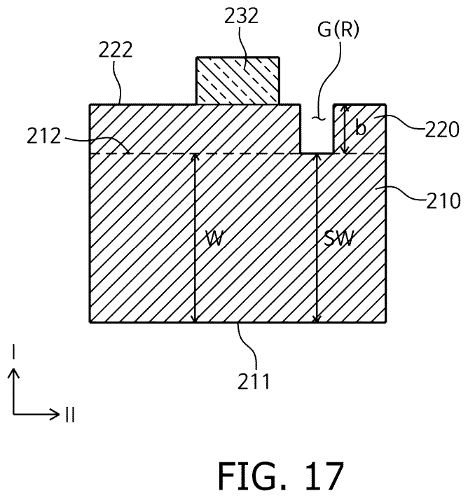

Referring to FIG. 17, the stamped electrode plate sheet ES may be cut into unit electrode plates to complete first modified electrode plates 201.

Each of the first modified electrode plates 201 may include the recess R having a depth corresponding to the protruding length PL of the auxiliary punch 54 and exposing the standard end 212 to generally increase the surface area of the extended sheet 220. In addition, because the standard end 212 may be sufficiently exposed through the recess R, the first modified electrode plates 201 may be sufficiently recognized by a conventional detection means during transportation of the first modified electrode plates 201.

Accordingly, each of the first modified electrode plates 201 having an increased surface area of the active material layer AL may be recognized without any additional configuration change in a conventional transportation line while increasing the capacity of the first modified electrode plate 201.

According to the above-described electrode plate for a secondary battery, a secondary battery having the electrode plate, and a method of manufacturing the electrode plate for a secondary battery, the area of the active material layer may be easily increased by providing a conventional standard sheet having a standard size and an extended sheet extending from the conventional standard sheet to have an extended width set from the standard size. Accordingly, the capacity of the electrode plate and the capacity of the stacked secondary battery having the electrode plate may be easily increased.

In particular, depending on the alignment position of the bottom of the tab punch and the uncoated portion, the surface area of the active material layer may be variably adjusted by increasing the extended width of the extended sheet by the maximum protruding length of the auxiliary punch. Accordingly, the capacity of the electrode plate can be variably increased.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. An electrode plate for a secondary battery, the electrode plate comprising:
a standard sheet configured to comprise a standard substrate coated with an active material, the standard substrate comprising a base end and a standard end spaced apart from the base end by a standard width in a first direction;
an extended sheet configured to comprise an extended substrate coated with the active material, the extended substrate comprising an extended end extending from the standard end by an extended width in the first direction; and
a tab connected to the extended substrate to extend in the first direction,
wherein at least one recess is provided such that the at least one recess is spaced apart from the tab by a gap distance in a second direction perpendicular to the first direction and the standard end is exposed.

2. The electrode plate as claimed in claim 1, further comprising a residual uncoated portion extending from the extended substrate having a predetermined residual thickness in the first direction and integrally connected to the tab and the extended substrate, the residual uncoated portion comprising an uncoated end spaced apart from the extended end by the residual thickness,
wherein the tab protrudes from the uncoated end in the first direction.

3. The electrode plate as claimed in claim 2, wherein the recess comprises a through-hole penetrating the residual uncoated portion and an extended groove capable of communicating with the through-hole and exposing the standard end, wherein a portion of the extended sheet being removed by an amount corresponding to the extended width from the extended end.

4. The electrode plate as claimed in claim 3, wherein a depth of the recess is a sum of a depth of the through-hole and a depth of the extended groove, and the depth of the through-hole and the depth of the extended groove are set complementarily to maintain the depth of the recess constant, and
the extended width and the residual thickness are configured complementarily to maintain the depth of the recess constant.

5. The electrode plate as claimed in claim 4, wherein, in a case where the standard width is 60 mm and the depth of the recess is set to 0.9 mm, the extended width is set to a range of 0.3 mm to 0.7 mm.

6. The electrode plate as claimed in claim 1, wherein the tab is integrally connected to the extended substrate and protrudes from the extended end in the first direction.

7. The electrode plate as claimed in claim 6, wherein the recess comprises an extended recess exposing the standard end, with a portion of the extended sheet being removed by an amount corresponding to the extended width from the extended end.

8. The electrode plate as claimed in claim 7, wherein a depth of the extended groove is fixed to be equal to a depth of the recess.

9. The electrode plate as claimed in claim 1, wherein the recess is provided as a stepped portion spaced apart from the tab to expose a standard end having a line shape in the second direction.

10. The electrode plate as claimed in claim 1, wherein the gap distance is greater than or equal to 0.5 mm and less than or equal to 1.5 mm.

11. A secondary battery comprising:
an electrode assembly configured to comprise a plurality of negative electrode plates each of the plurality of negative electrode plates comprising a negative electrode tab, a plurality of positive electrode plates having a size smaller than the size of the negative electrode plates, alternately stacked with the negative electrode plates in a third direction to have a same stacking distance from edges of the negative electrode plates, and each of the plurality of negative electrode plates comprising a positive electrode tab, and a plurality of separators disposed between the negative electrode plates and the positive electrode plates;
electrode leads configured to comprise a single negative electrode lead joined to the negative electrode tab and a single positive electrode jointed to the positive electrode tab; and
a battery can configured to comprise the electrode assembly and the electrode leads, the battery can comprising electrode terminals connected to the electrode leads,
wherein the positive electrode plate comprises:
a standard sheet configured to comprise a standard substrate coated with an active material, the standard substrate comprising a base end and a standard end spaced apart from the base end by a standard width in a first direction perpendicular to the third direction;
an extended sheet configured to comprise an extended substrate coated with the active material, the extended substrate comprising an extended end extending from the standard end by an extended width in the first direction; and
a tab connected to the extended substrate to extend in the first direction,
wherein at least one recess is provided to be spaced apart from the tab by a gap distance in a second direction perpendicular to the first direction and to expose the standard end.

12. The secondary battery as claimed in claim 11, wherein the positive electrode plate further comprises a residual uncoated portion extending from the extended substrate having a predetermined residual thickness in the first direction and integrally connected to the tab and the extended substrate, the residual uncoated portion comprising an uncoated end spaced apart from the extended end by the residual thickness,
wherein the tab protrudes from the uncoated end in the first direction.

13. The secondary battery as claimed in claim 12, wherein the recess comprises a through-hole penetrating the residual uncoated portion and an extended groove communicating with the through-hole and exposing the standard end, with a portion of the extended sheet being removed from the extended end by an amount corresponding to the extended width.

14. The secondary battery as claimed in claim 13, wherein a depth of the recess is a sum of a depth of the through-hole and a depth of the extended groove, and the depth of the through-hole and the depth of the extended groove are set complementarily to maintain the depth of the recess constant, and
the extended width and the residual thickness are configured complementarily to maintain the depth of the recess constant.

15. The secondary battery as claimed in claim 12, wherein the stacking distance is set to a distance between edges of the negative electrode plates and the extended end and varies depending on the residual thickness.

16. The secondary battery as claimed in claim 11, wherein the tab is integrally connected to the extended substrate and protrudes from the extended end in the first direction, and
the recess comprises an extended recess exposing the standard end, with a portion of the extended sheet being removed from the extended end by an amount corresponding to the extended width.

17. A method of manufacturing an electrode plate for a secondary battery, the method comprising:
supplying an electrode plate sheet comprising an active material layer of an active material applied over a substrate having a width in a first direction and a length in a second direction and an uncoated portion provided on a peripheral portion of the substrate to which the active layer is not applied;
controlling a stamping machine comprising a tab punch, a base punch positioned symmetrically with the tab punch in the first direction, and an auxiliary punch protruding from a bottom of the tab punch toward the base punch to set a distance between the auxiliary punch and the base punch in the first direction as a standard width;
aligning the bottom of the tab punch to overlap the uncoated portion; and
partially removing the electrode plate sheet using the stamping machine to form a recess exposing a base end which is a portion of the substrate cut by the base punch, a tab which is an uncoated portion corresponding to the tab punch, and a standard end corresponding to the auxiliary punch, the standard end being a portion of the substrate cut to be spaced apart from the base end by the standard width in the first direction; and
exposing the active material layer covering the standard end through the recess.

18. The method as claimed in claim 17, wherein the tab punch comprises a pair of punch bodies spaced apart from each other in the second direction and is disposed to have a predetermined gap distance in the second direction from opposite sides of the punch bodies, and
the recess is configured to be spaced apart from the tab by the gap distance.

19. The method as claimed in claim 17, wherein the bottom of the tab punch is aligned with the uncoated portion to be spaced apart from the active material layer to form a residual uncoated portion between the tab and the active material layer, and
the recess comprises a through-hole penetrating the residual uncoated portion and an extended groove communicating with the through-hole and exposing the standard end, with a portion of the extended sheet being removed from an extended end by an amount corresponding to the extended width.

20. The method as claimed in claim 17, wherein the bottom of the tab punch is aligned with an extended end, which is an end of the active material layer, such that the tab is directly connected to the extended end, and
the recess is formed as an extended groove recessed from the extended end to the standard end.
